(19) United States
(12) Patent Application Publication
(10) Pub. No.: US 2023/0392948 A1
(43) Pub. Date: Dec. 7, 2023

(54) VEHICLE COMMUNICATION AND NAVIGATION SYSTEMS FOR ROAD SAFETY

(71) Applicant: MICRON TECHNOLOGY, INC., BOISE, ID (US)

(72) Inventors: Aysha Shanta, Boise, ID (US); Carla Christensen, Garden Valley, ID (US); Leticia Vazquez Bengochea, Taichung City (TW)

(21) Appl. No.: 17/859,045

(22) Filed: Jul. 7, 2022

Related U.S. Application Data
(60) Provisional application No. 63/348,375, filed on Jun. 2, 2022.

(51) Int. Cl. G01C 21/36; G08G 1/01; G08G 1/0969

(52) U.S. Cl. CPC G01C 21/3691; G08G 1/0141; G01C 21/3629; G08G 1/0133; G01C 21/3667; G08G 1/0969

(57) ABSTRACT

Systems, methods, and apparatuses related to vehicle navigation systems are described. A first vehicle may encounter an environmental condition. The first vehicle may be in communication with a second vehicle having a route that is proximate the proximate condition. The first vehicle may detect an environmental condition using a sensor on the first vehicle and determine certainty of the environmental condition above a threshold. The second vehicle may be notified about the environmental condition detected by the first vehicle based on an expectation that the second vehicle may encounter the environmental condition. The second vehicle may re-route in response to the environmental condition, and/or integrate the environmental condition in the navigation map.

### CROSS-REFERENCE TO RELATED APPLICATION

This application claims the filing benefit of U.S. Provisional Application No. 63/348,375, filed Jun. 2, 2022. This application is incorporated by reference herein in its entirety and for all purposes.

### TECHNICAL FIELD

Examples described herein relate to vehicle communication and navigation systems. Examples of detection of road conditions and communicating with other vehicles regarding same are described herein.

### BACKGROUND

Computing devices such as a smartphone, a smart car, and a tablet, often include navigation systems that provide guidance for drivers to determine the best route to reach the destination. For example, a navigation system may predict a travel time based on traffic and route information and suggest a route that has the least travel time or a route that has the shortest distance between the driver and the destination.

As another example, a navigation system may provide static traffic information (e.g., locations of traffic lights and/or stop signs) on a recommended route. The recommended route may be a route with the least amount of traffic lights and/or stop signs. However, dynamic traffic information (e.g., color of the traffic lights, temporary speed limit change zone) on the recommended route may be helpful to a driver. For example, a driver may find a real-time update of traffic lights to be helpful in navigation. As another example, an inexperienced or an old driver may find real-time updates relating to temporary speed limit changes or school zone speed limit reminders helpful. As another example, a driver may find information about upcoming traffic lights around a blind curve reassuring in the driving experience. Therefore, it may be beneficial to provide efficient data processing for such context-based automotive safety applications.

Cloud navigation has been a growing interest in many navigation systems. For example, a cloud service provider may receive traffic information from a first vehicle and transmit the traffic information to other vehicles in the network. Individual navigation systems in the other vehicles may recommend an alternative route over an original recommended route based on the traffic information provided by the first vehicle. However, it may be favorable to limit the amount of information shared to or obtained from the network due to bandwidth available in communication systems.

### BRIEF DESCRIPTION OF THE DRAWINGS

FIG. 1 is a schematic illustration of a system arranged in accordance with examples described herein.

FIG. 2 is a schematic illustration of an example computing device arranged in accordance with examples described herein.

FIG. 3 is a schematic illustration of an example system arranged in accordance with examples described herein.

FIG. 4 is a flowchart illustrating a method arranged in accordance with examples described herein.

FIG. 5 is a flowchart illustrating a method arranged in accordance with examples described herein.

FIG. 6 is a schematic illustration of an example navigation map integrating a state of a dynamic road condition in accordance with examples described herein.

FIG. 7 is a flowchart illustrating a method arranged in accordance with examples described herein.

FIG. 8 is a flowchart illustrating a method arranged in accordance with examples described herein.

### DETAILED DESCRIPTION

A driver may utilize a navigation system that recommends a route for the driver to reach the destination. The navigation system may display the recommended route and alternative route(s) based on shortest travel time, shortest distance, and/or user preferences. For example, the navigation system may recommend a route that is more energy efficient but would take the driver longer to reach the destination and also present a route that would take the least time for the driver to reach the destination but includes poor road conditions.

The navigation system may display a road condition on a map. For example, the navigation system may receive reports of road conditions such as constructions, fallen trees, car accidents, speed trap, etc. Some road conditions may cause delay to the originally recommended route which may prompt the navigation system to recommend an alternative route. Examples described herein may advantageously utilize the navigation system that may be coupled to a sensor (e.g., camera) to detect a road condition and share information relating to the road condition to another vehicle when the road condition is equal to or above a threshold. A threshold may include reports of the road condition from multiple sources. For example, a second vehicle may also detect and report the same road condition thus confirming the road condition. In this example, the threshold has been met. Other navigation systems that recommend a route including the road condition may receive an alert about the road condition that met or exceeded the threshold and compute a new travel time of the recommended route.

Examples according to various aspects of the present disclosure provide additional assistance to the driver based on dynamic (e.g. time varying) road conditions in which the driver may appreciate detailed information associated with the road conditions. For example, a vehicle may stop in front of a red traffic light. The sensor coupled to the vehicle may detect the traffic light is red and the vehicle may communicate with a nearby vehicle that the state of the traffic light (e.g., Red traffic light). The navigation system of the nearby vehicle may reflect the state of the traffic light on the map. In examples, the navigation system may recognize that the vehicle has entered a school zone where when there is a child nearby, the speed limit changes. The vehicle may detect there is a child nearby and notify a vehicle nearby of the child. The navigation system of the nearby vehicle may send alerts to the driver to drive with the appropriate speed. These improvements help the driver be aware of the surroundings and overall ensure safety to the road users.

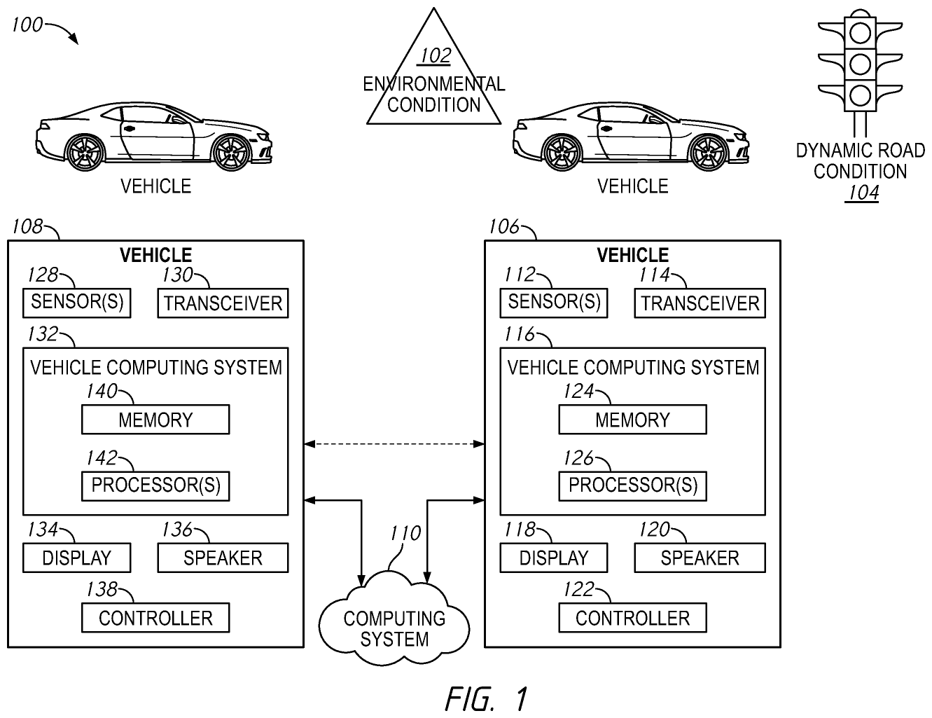

FIG. 1 is a schematic illustration of multiple vehicles on a road provided with an environmental condition 102 and a dynamic road condition 104. The system 100 includes a first vehicle 106 and a second vehicle 108. In the example shown in FIG. 1, the first vehicle 106 is followed by the second vehicle 108. The first vehicle 106 may include a plurality of sensor(s) 112, a transceiver 114, a vehicle computing system 116, a display 118, a controller 122, and optionally a speaker 120. The vehicle computing system 116 may include memory 124 and a plurality of processor(s) 126. Similarly, the second vehicle 108 may include may include a plurality of sensor(s) 128, a transceiver 130, a vehicle computing system 132, a display 134, a controller 138, and optionally a speaker 136. The vehicle computing system 132 may include memory 140 and a plurality of processor(s) 142. While described as vehicles in FIG. 1, the first vehicle 106 and/or the second vehicle 108 may be generally implemented by one or more wireless communication devices For example, a mobile device carried by a cyclist.

While two vehicles are shown in FIG. 1, any number may be present in other examples including 3, 4, 5, 6, 7, 8, 9, 10, 50, 100, 500, 1000, or another number of vehicles. Any of a variety of vehicle types may implement systems and methods described herein including, but not limited to, automobiles (e.g., passenger cars, taxis, ride share vehicles), trucks (e.g., semi-trucks, heavy equipment, service trucks such as but not limited to delivery trucks, garbage trucks, postal vehicles), busses, trains, driverless vehicles, or combinations thereof.

Vehicles described herein, such as first vehicle 106 and second vehicle 108 of FIG. 1, may be equipped with one or more sensor(s) 112 and sensor(s) 128 of FIG. 1. The sensors may be integrated with the vehicle and placed on, in, around, above, below, and/or proximate to the vehicle. Each sensor may be used to sense one or more environmental parameters. Examples of sensors which may be used include, but are not limited to, optical sensors (e.g., cameras, infrared sensors), temperature sensors, accelerometers, gyroscopes, inertial sensors, humidity sensors, RADAR sensors (e.g., LiDARs), ultrasonic sensors, rain sensors, vehicle parameter sensors (e.g., sensors used to sense a position and/or state of one or more vehicle components, such as but not limited to, a wheel position sensor, a wheel speed sensor, an airspeed sensor), altimeter, or combinations thereof.

Vehicles described herein, such as first vehicle 106 and second vehicle 108 of FIG. 1, may be equipped with one or more transceivers (e.g., transceiver 114 and transceiver 130 of FIG. 1). The transceiver may include one or more receivers, transmitters, or combinations thereof. Transceivers described herein may be used to transmit and/or receive data from a variety of sources, including other vehicles and/or other computing systems. For example, the transceiver 114 may be used to transmit vehicle data pertaining to the first vehicle 106, which data may be generated by sensor(s) 112. The transceiver 130 may be used to receive vehicle data pertaining to the second vehicle 108, which may be generated by sensor(s) 128. Data transmitted by the transceiver 114 may be received by second vehicle 108 and/or other computing system 110. Transceiver 114 may be used to receive data from other computing system 110 in some examples. In an analogous manner, the transceiver 130 may be used to transmit vehicle data pertaining to the second vehicle 108, which may be generated by sensor(s) 128. The transceiver 130 may be used to receive vehicle data pertaining to the first vehicle 106, which may be generated by the sensor(s) 112. Data transmitted by the transceiver 130 may be received by the first vehicle 106 and/or other computing system 110. Transceiver 130 may be used to receive data from other computing system 110 in some examples.

Transceivers described herein generally transmit and/or receive data using wireless communication techniques. In some examples, transceivers, such as transceiver 114 and transceiver 130 may communicate using 5G wireless communication techniques. 5G wireless communication techniques may, in some examples, allow for adequate bandwidth and speed of communications such that sensor data from one vehicle (e.g., first vehicle 106) may timely be received by another vehicle (e.g., second vehicle 108) and utilized by the receiving vehicle to impact the operation of the receiving vehicle (e.g., driving). In some examples, transceivers described herein, such as transceiver 114 and/or transceiver 130 may utilize full duplex communication techniques, including full duplex 5G wireless communication techniques. Accordingly, the transceiver 114 and/or transceiver 130 may substantially simultaneously both transmit and receive data in some examples. The transceiver 114 and/or transceiver 130 may be equipped with interference cancellation circuitry which may facilitate the simultaneous transmission and receipt of data in some examples.

Vehicles described herein, such as first vehicle 106 and second vehicle 108 of FIG. 1, may include one or more controllers, such as controller 122 and controller 138 shown in FIG. 1. The controllers may provide control signals to one or more components of the vehicle, including control signals used to control the display of the vehicle. For example, the controllers may provide control signals to display a detected situation by the sensor(s) of the vehicle. Other aspects of the vehicle may be controlled by controllers described herein (e.g., the speed, setting, heading, or operation of any component of the vehicles). Accordingly, the controllers, such as controller 122 and/or controller 138 may be in electrical and/or mechanical (e.g., pneumatic) communication with a variety of components of the vehicle. In some examples, multiple controllers may be provided in each vehicle. Controllers described herein may be in communication, either directly or indirectly through other vehicle components, with sensors of the vehicle, such as sensor(s) 112 and/or sensor(s) 128. In this manner, readings from the sensors may be used as inputs to the controller 122 which may provide control signals according to sensor readings. Controllers described herein may be implemented using any number or variety of processing unit(s), including but not limited to, processors, circuitry (e.g., application specific integrated circuits (ASICs), field programmable gate arrays (FPGAs)), and/or microcontrollers.

Vehicles described herein, such as the first vehicle 106 and second vehicle 108 of FIG. 1, may include a screen or touch screen implementing the display 118 and display 134 and a speaker (e.g., speaker 120 and speaker 136). In some examples, the vehicles may additionally include a user interface (not shown) including input or output devices or circuits, such as a microphone, a keyboard, or a panel, or combinations thereof. In some examples, the display 119 and display 134 (and/or optionally speakers 120, 136) may implement at least a portion of the user interface, for example, when the user interface is a graphical user interface.

Examples of vehicles described herein may include a subsystem, such as vehicle computing system 116 and vehicle computing system 132 shown in FIG. 1. The memory 124 and processor(s) 126 may be components of the vehicle computing system 116 of the first vehicle 106. The memory 140 and processor(s) 142 may be components of the vehicle computing system 132 of the second vehicle 108. A navigation system for the first vehicle 106 may be implemented using the processor(s) 126 and memory 124. A navigation system for the second vehicle 108 may be implemented using the processor(s) 142 and memory 140. The memory 124 and memory 140 may store map data such as roads, intersections, user preferences, existing map information, road signs, exit information (e.g. locations of gas stations, restaurants, hotels hospitals rest areas), and locations of traffic lights. The memory 124 and memory 140 of the first vehicle 106 and the second vehicle 108 may store dynamic road conditions (e.g. dynamic traffic signs). In some examples, the dynamic road conditions may include an availability or current status of the exit information. For example, the dynamic road conditions may indicate whether the gas stations and restaurants are open and whether the hotels and rest areas are available.

The processor(s) 126 of the first vehicle 106 and the processor(s) 142 of the second vehicle 108 may predict a travel time between a start point and an end point entered by the user. In some examples, the processor(s) 126 and processor(s) 142 may be authorized to access a digital calendar and calculate a travel time between the user's departing location and the destination. The processor(s) 126 and processor(s) 142 may compute a plurality of routes and recommend one route based on travel distance, travel time, the user's preferences, or combinations thereof. In some examples, the processor(s) 126 and processor(s) 142 may predict an updated travel time based on the integration the dynamic road conditions stored in the respective memory and the map data. If the updated travel time exceeds the original recommend route, the processor(s) 126 and processor(s) 142 may recommend alternative routes.

The navigation system may display a road condition on a map. For example, the navigation system may receive reports of road conditions such as constructions, fallen trees, car accidents, speed trap, etc. Some road conditions may cause delay to the originally recommended route which may prompt the navigation system to recommend an alternative route. Examples described herein may advantageously utilize the navigation system that may be coupled to a sensor (e.g., camera) to detect a road condition and share information relating to the road condition to another vehicle when the road condition is above a threshold. For example, a second vehicle may also detect and report the same road condition thus confirming the road condition. In this example, the threshold has been met. Other navigation systems that recommend a route including the road condition may receive an alert about the road condition and compute a new travel time of the recommended route.

Examples of systems described herein may include one or more computing systems, such as other computing system 110 in FIG. 1. The computing system 110 may be in communication with one or more of the vehicles described herein and may provide all or portions of the processing described herein, and/or may provide additional sensor data for use by cooperative learning neural networks described herein. Examples of other computing system 110 which may be used include, but are not limited to, sensor devices which may transmit data from another location in the environment proximate one or more of the vehicles (e.g., sensors along a road, at a toll booth, in pavement). Other examples of other computing system 110 include computing resources located remotely from one or more vehicles but in electronic communication with the vehicle (e.g., one or more computing resources accessible over a network, from a cloud computing provider, or located in the environment of one or more vehicles). The first vehicle 106 may communicate with a second vehicle 108. In some examples, the first vehicle 106 may communicate with the second vehicle 108 via a computing system 110 including a network. In other examples, the first vehicle 106 may directly communicate with the second vehicle 108. In some examples, the second vehicle 108 may have the same configuration as the first vehicle 106. Additionally, fewer and/or different components and parts may be present in other examples.

In a first embodiment, the first vehicle 106 encounters environmental condition 102 using the sensor(s) 112. The environmental condition 102 may be a pothole, rockslide, rising water level, snow, road closure, fallen tree, fallen objects (e.g. ladder, log), wildfires, strong winds, or combinations thereof. In some examples, one or more criteria may be used to identify the environmental condition and determine a certainty of the environmental condition 102. If the certainty is equal to or above a threshold, data relating to the environmental condition 102 may be transmitted to other vehicles. For example, the sensor(s) 112 of the first vehicle 106 may generate sensor data based on the environmental condition 102 and the vehicle computing system 116 may receive the sensor data. The processor(s) 126 of the vehicle computing system 116 may analyze the sensor data and identify the type of the environmental condition. In some examples, the processor(s) 126 may further cause the transceiver 114 to transmit a report of the environmental condition 102 to the computing system 110. The computing system 110 may transmit data pertaining to the environmental condition 102 to other vehicles (e.g., second vehicle 108) in proximity of the environmental condition 102 based on a threshold. The threshold may be a minimum certainty (e.g. confidence value) that the environmental condition 102 exists.

In other examples, the first vehicle 106 may generate sensor data related to the environmental condition 102 and transmit the sensor data to the computing system 110. The computing system 110 may utilize a threshold based on a number of reports of the environmental condition 102 from vehicles. For example, it may be determined that when the computing system 110 receives at least a predetermined number of reports of the environmental condition 102, the computing system 110 is configured to determine a certainty of the environmental condition 102. The computing system 110 may be further configured to notify other vehicles (e.g. second vehicle 108) via the transceiver 130 about the environmental condition 102. The user of the second vehicle 108 may have a preference of only receiving a report if the computing system 110 receives at least a preferred number of reports. In some examples, the preferred number of reports may be higher than the threshold provided to the computing system 110.

While the threshold may be a number of reports received by the computing system 110, the computing system 110 may be configured to notify the other vehicles (e.g., second vehicle 108) if there is a number of reports received over a predetermined period of time (e.g., time elapsed since the first report, every minute, every 5 minutes, etc.). For example, the computing system 110 may be configured to notify other vehicles if the computing system 110 receives at least two reports within one minute since the first report. Therefore, if the computing system 110 receives two reports of environmental condition 102 within one minute, it notifies the other vehicles (e.g., second vehicle 108) proximate the environmental condition 102 that data relating to the environmental condition in the upcoming route. If the computing system 110 does not receive at least two reports within one minute (e.g., only one report within one minute since the first report), the computing system 110 does not notify other vehicles.

In some examples, the computing system 110 may predict an anticipated traffic along the route based on a history of traffic of the route, traffic of neighboring routes, a number of navigation systems recommending the route, or combinations thereof. In some examples, the threshold may vary depending on the anticipated or known traffic along the route where the environmental condition 102 is reported. For example, if the computing system 110 predicts the anticipated traffic to be busy, the threshold to notify other vehicles may be higher than a less busy anticipated traffic (e.g., more vehicles to report the environmental condition 102 within one minute). In another example, if there has not been reports of the environmental condition 102 despite heavy traffic, the computing system 110 may be confident that the environmental condition 102 no longer exists. Therefore, the certainty of the environmental condition 102 is determined to be less than the threshold and the computing system 110 does not notify other vehicles such as the second vehicle 108 of FIG. 1. In some examples, the computing system 110 may update other vehicles that the environmental condition 102 has been resolved when the certainty of the environmental condition 102 is less than the threshold.

In some examples, the value of the threshold may be adjusted based on a calculated percentage of vehicles reporting the environmental condition 102 along the route over a period of time. For example, there may be fewer reports of the environmental condition 102 because there is generally less traffic or the environmental condition 102 no longer exists. Therefore, the value of the threshold may be updated from ten reports in one hour to five reports in one hour or ten reports in three hours.

When it is determined that the certainty is above the threshold, the computing system 110 may communicate with the second vehicle 108 and notify the second vehicle 108 of the environmental condition 102. In other examples, the transceiver 114 of the first vehicle 106 may directly communicate with the second vehicle 108 based on the proximity between the first vehicle 106 and the second vehicle 108.

The second vehicle 108 may be determined to be proximate the environmental condition 102 based on a geometrical relationship between the first vehicle 106 and the second vehicle 108. For example, the second vehicle 108 may be 100, 200, 500, 1,000 feet away from the first vehicle 106. In other examples, the second vehicle 108 may be en route to the environmental condition 102 and is expected to encounter the environmental condition 102 within 30 seconds, 1 minute, 2 minutes, 5 minutes, 10 minutes, etc. If the second vehicle 108 receives from the computing system 110 that there is an upcoming environmental condition 102, the processor(s) 142 may generate a plurality of alternative routes to avoid the environmental condition 102. The processor(s) 142 may further suggest the second vehicle 108 to re-route and cause the display 134 of the second vehicle 108 to display the plurality of alternative routes. In some examples, the display 134 may be configured to display the environmental condition 102 on the route map. In other examples, the speaker 136 may further be configured to verbally describe the upcoming environmental condition 102 and prompt the driver of the second vehicle 108 to decide whether to pursue an alternative route.

In a second embodiment illustrated in FIG. 1, the first vehicle 106 encounters a dynamic road condition 104 using the sensor(s) 112. Examples of the dynamic road condition 104 include a traffic light, a stop sign, a speed limit change sign, construction activity, road closure, detour route, a school zone indicator, a warning sign, a road sign, or combinations thereof. The sensor(s) 112 transmits data pertaining to the dynamic road condition 104 to the vehicle computing system 116. The processor(s) 126 of the vehicle computing system 116 may analyze the sensor data and identify a state of the dynamic road condition 104 (e.g., color of the traffic light). The processor(s) 126 may further cause the transceiver 114 to communicate the dynamic road condition 104 with the second vehicle 108 proximate the first vehicle 106 via direct communication or the computing system 110. The computing system 110 may forward data about the dynamic road condition 104 to a plurality of vehicles (e.g., second vehicle 108) that has a route that is proximate the dynamic road condition 104. In other examples, data about the dynamic road condition 104 may be communicated from the first vehicle 106 to the second vehicle 108 based on a distance between the first vehicle 106 and the second vehicle 108. In other examples, the proximity may be established if the second vehicle 108 is on a route that is close to the dynamic road condition 104.

In some examples, the first vehicle 106 may periodically transmit data related to the dynamic road condition 104 for a certain period of time, e.g., for as long as the first vehicle 106 detects the dynamic road condition 104. In other examples, the first vehicle 106 may only transmit data related to the dynamic road condition 104 when there is a change in the state of the dynamic road condition 104 (e.g., change of color of a traffic light). In other examples, the first vehicle 106 may notify the second vehicle 108 that the first vehicle 106 is no longer near the dynamic road condition 104 and terminate the connection between the first vehicle 106 and the second vehicle.

When the transceiver 130 of the second vehicle 108 receives data pertaining to the dynamic road condition 104 from the first vehicle 106 that is proximate the dynamic road condition 104, the processor(s) 142 of the second vehicle 108 may cause the display 134 to display the dynamic road condition 104. The second vehicle 108 may include a communication interface (not shown in FIG. 1), allowing a user of the second vehicle 108 to provide their preferences for the display, frequency of receiving a status of the dynamic road condition 104, notification means, types of dynamic road condition 104 that trigger a notification, feedback about the notifications, or combinations thereof. The user's preferences may be stored in the memory 140. The memory 140 may also store the map data and a library of dynamic road conditions as described above. The processor(s) 142 of the second vehicle 108 may integrate the state of the dynamic traffic sign with the map data and generate a new navigation map based on the integration. The processor(s) 142 may use the controller 138 to cause the display 134 to display the new navigation map. The processor(s) 142 may use the controller 138 to cause the speaker 136 to audibly describe the state of the dynamic road condition 104.

In some examples, the processor may compare the recommended route which includes the dynamic road condition 104 with at least one alternative route between the start point and the destination. The alternative route does not include the dynamic road condition 104. The processor(s) 142 may further predict a travel time associated with the original recommended route and a second travel time associated with the alternative route. For example, if the original recommended route has a less travel time than the alternative route, the processor(s) 142 may recommend the original recommended route and cause the display 134 to display the navigation map integrating the dynamic road condition 104. In another example, if the original recommended route has a longer travel time than the alternative route, the processor(s) 142 may determine that the alternative route should be recommended instead of the original recommended route. The processor(s) 142 may cause the display 134 to display a navigation map showing the alternative route. In some examples, the processor(s) 142 may generate more than one alternative route and recommend a route that requires the least travel time between the start point and the destination.

The computing system 110 may receive an alert to be broadcasted to vehicles in a particular region. The alert may be a government issued alert (e.g., amber alerts, silver alerts, blue alerts, etc.). The alert may be related to adverse road conditions (e.g., chain requirement). The alert may be related to natural disasters (e.g., cyclone, earthquake, storm, tornado, tsunami). The alert may be related to crime activities (e.g., shooting, robbery). In some examples, the alert is communicated to the computing system 110 from a local government broadcast channel. In other examples, the alert may be received by the computing system 110 from a news source.

The computing system 110 may transmit data of the alert to the transceivers of the vehicles in the particular region (e.g., transceiver 114 of the first vehicle 106 and transceiver 130 of the second vehicle 108). In the example of the first vehicle 106 receiving the data from the computing system 110, the vehicle computing system 116 may process the alert and cause the controller 122 to display the alert via e.g., a text box via the display 118, a notification sound via the speaker 120, vibrations, and/or other feedback options chosen by the first user. In some examples, the controller 122 may display the alert using the preferred method(s) and display only alerts based on the first user's preferences of the types of alerts (e.g. regional alerts and/or alerts from nearby vehicles) to be displayed. In some examples, the vehicle computing system 116 may identify the type of the alert and assign a corresponding notification method. A similar notification method may be implemented by the second vehicle 108.

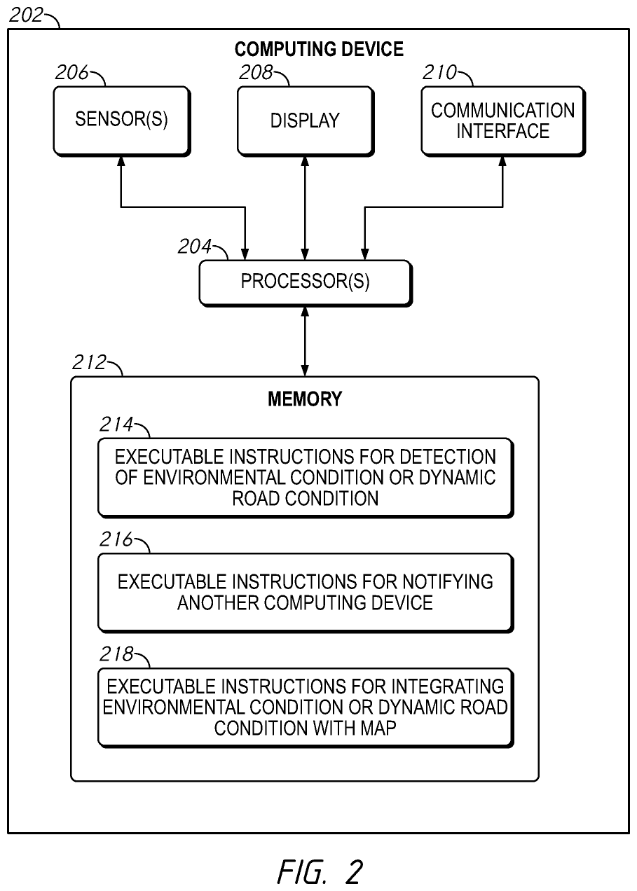

FIG. 2 is a schematic illustration of a computer device arranged in accordance with examples described herein. The computing device 202 includes sensor(s) 206 that detects road conditions. The computing device 202 includes display 208, communication interface 210, processor(s) 204, and a memory 212. The memory 212 includes executable instructions for detection of environmental condition or dynamic road condition 214, executable instructions for integrating environmental condition or dynamic road condition with map 218, and executable instructions for notifying another computing device 216. Additionally, fewer, and/or different components may be present in other examples. For example, the computing device 202 may include one or more communication interface 210, one or more display 208, additional memory and/or electronic storage, and/or additional storage. The processor(s) 204 may execute instructions stored in memory 212 and/or in other computer readable media accessible to the computing device 202 and/or processor(s) 204 in a navigation system.

Examples of systems described herein may accordingly include computing devices. Computing device 202 is shown in FIG. 2. In some examples, the computing device 202 may be implemented by the vehicle computing system 116 of the first vehicle 106 and/or the vehicle computing system 132 of the second vehicle 108 of FIG. 1. Generally, a computing device may include a smart phone and any electronic device in communication with a sensor as described herein and with one or more processors and/or communication interfaces to detect a road condition and communicate with other computing devices. Additionally or alternatively, the computing device may also be in communication with one or more other computing devices to receive notifications about upcoming road conditions and/or dynamic road conditions. A computing device may or may not have cellular phone capability, which capability may be active or inactive. In some examples, a built-in navigation system provided in a vehicle may be implemented. Other electronic devices such as, but not limited to, tablets, laptops, computers, or appliances. Generally, any device having a sensor and processor(s) may be used.

Computing devices described herein may include one or more processors, such as processor(s) 126 or processor(s) 142 of FIG. 1 and processor(s) 204 of FIG. 2. Any number or kind of processing circuitry may be used to implement processor(s) 204 such as, but not limited to, one or more central computing units (CPUs), graphical processing units (GPUs), logic circuitry, field programmable gate arrays (FPGAs), application specific integrated circuits (ASICs), controllers, or microcontrollers. While certain activities described herein may be described as performed by the processor(s) 204, it is to be understood that in some examples, the activities may wholly or partially be performed by one or more other processor(s) which may be in communication with processor(s) 204. That is, the distribution of computing resources may be quite flexible and the computing device 202 may be in communication with one or more other computing devices, continuously or intermittently, which may perform some or all of the processing operations described herein in some examples.

Computing devices described herein may include memory, such as memory 212 of FIG. 2. In some examples, memory 124 of FIG. 1 or memory 140 of FIG. 1 may be implemented. While memory 212 is depicted as integral with computing device 202, in some examples, the memory 212 may be external to computing device 202 and may be in communication with processor(s) 204 and/or other processors in communication with computing device 202. While a single memory 212 is shown in FIG. 2, generally any number of memories may be present and/or used in examples described herein. Examples of memory which may be used include read only memory (ROM), random access memory (RAM), solid state drives, and/or SD cards.

Computing devices described herein may operate in accordance with software (e.g., executable instructions stored on one or more computer readable media, such as memory, and executed by one or more processors). Examples of software may include executable instructions for detection of environmental condition or dynamic road condition 214, executable instructions for notifying another computing device 216, and/or executable instructions for integrating environmental condition or dynamic road condition with map 218 of FIG. 2. For example, the executable instructions for detection of environmental condition or dynamic road condition 214 may provide instructions and/or settings for detecting a dynamic road condition (e.g., dynamic road conditions 104 as described with respect to FIG. 1) by sensor(s) 206 and/or based on data received from sensor(s) 206. The sensor(s) 206 may be implemented by the sensor(s) 112 of the first vehicle 106 and/or the sensor(s) 128 of the second vehicle 108 of FIG. 1.

The executable instructions for detection of environmental condition or dynamic road condition 214 may provide instructions to determine a certainty of the detected environmental condition or dynamic road condition based on a frequency of the detection of the environmental condition or dynamic road condition. If the certainty is higher than a threshold stored on the memory 212, the executable instructions for detection of environmental condition or dynamic road condition 214 may determine the computing device 202 will notify other computing devices of the environmental condition or dynamic road condition.

The executable instructions for notifying another computing device 216 may include instructions and/or settings for transmitting data related to the dynamic road condition to another computing device (e.g., another vehicle). In some examples, a transceiver may be utilized (e.g., transceiver 114 of the first vehicle 106 and/or transceiver 130 of the second vehicle 108 shown in FIG. 1) to transmit data related to the environmental condition or dynamic road condition to another computing device. In other examples, the transceiver may transmit data to a remote computing system, such as the computing system 110 of FIG. 1. In some examples, the data related to the environmental condition or dynamic road condition is sent to another computing device or another computing system responsive to the certainty of the detected environmental condition or dynamic road condition being higher than a threshold. In other examples, the data related to the environmental condition or dynamic road condition is transmitted to another computing device or another computing system regardless of the certainty. For example, the data may be transmitted to the computing system 110 of FIG. 1 and the computing system 110 determines a certainty of the environmental condition or dynamic road condition based on a frequency or number of reports before notifying other vehicles of the environmental condition or dynamic road condition.

The executable instructions for integrating environmental condition or dynamic road condition with map 218 may integrate the environmental condition or dynamic road condition into a navigation map. In some examples, the environmental condition or dynamic road condition is only integrated into the map if the certainty is higher than the threshold. In other examples, the environmental condition or dynamic road condition is displayed on the map regardless of the certainty. Instead, the user preferences may indicate when and how the environmental condition or dynamic road condition is displayed on the map. The display 208 may be coupled to the processor and display the integration of the environmental condition or dynamic road condition on the navigation map. The communication interface 210 may be coupled to the processor(s) 204 to communicate the user preferences for when and how the environmental condition or dynamic road condition is integrated with the map on the display. The communication interface 210 may include receiving feedback from the user about the accuracy and updated about the environmental condition or dynamic road condition. The communication interface 210 may receive feedback from the user regarding the environmental condition or environmental condition.

According to the first embodiment, during operation, the sensor(s) 206 may detect an environmental condition (e.g., the environmental condition 102 of FIG. 1). The environmental condition may be a pothole, rockslide, rising water level, snow, road closure, fallen tree, fallen objects (e.g. ladder, log), wildfires, strong winds or combinations thereof. The sensor(s) 206 may send the sensor data to the processor(s) 204. The processor(s) 204 may compare the sensor data received from sensor(s) 206 with stored data relating various environmental conditions. If the certainty of the environmental condition is above a threshold (e.g., above 30%, above 50%, above 70%, or above 90%), the processor(s) 204 may load the executable instructions for notifying another computing device 216. The certainty of the environmental condition may be based on a similarity comparison between the collected data and the stored data. For example, a camera may capture images of an environmental condition. The processor(s) 204 may compare the captured images with the library of images related to potholes stored in the memory 212. For example, based on a comparison of the light contrast that is typical in a pothole and that of a smooth road, the processor(s) 204 may identify the environmental condition to be a pothole. Other techniques for identification of potholes may be used in other examples.

Additionally or alternatively, an accelerometer and/or a gyroscope may be used to detect vibrations such as shocks induced by a pothole. In some examples, the processor(s) 204 may identify a pothole by comparing the amplitude of the detected signal (e.g., root mean square) with a predetermined threshold. Responsive to the amplitude of the detected signal exceeding the threshold indicative of a smooth pavement, the processor(s) 204 may determine the environmental condition is a pothole.

When a vehicle is moving at a high speed and encounters a pothole, the vehicle may experience a shock that is stronger than when it drives on a smooth pavement because of the sudden dip. Therefore, it may be possible to identify the pothole because the amplitude of the signal for the pothole may be higher than the amplitude of the signal for a smooth pavement. In another example, the three-axis acceleration data may be used to determine if the vehicle encounters a pothole. For example, the vehicle may temporarily be in freefall when entering or exiting the pothole. A pothole may also be characterized by the lateral acceleration value (x-axis) and the vertical acceleration value (z-axis) exceeding a specified threshold. Driving conditions such as vehicle acceleration/deceleration and turning that are unrelated to the environmental condition may be filtered where low-frequency component of the vibrations caused by acceleration/deceleration may be removed and high-frequency component of the signal related to the environmental condition may be retained. Similarly, a filter may be applied to remove components caused by the speed change of the vehicle and the gravity component. Accordingly, the acceleration data used by the processor(s) 204 to compare against the threshold data may reflect the environmental condition without noise. If the processor(s) 204 determines the detected signal is indicative of an environmental condition, the processor(s) 204 may load the executable instructions for notifying another computing device 216.

In some examples, the processor(s) 204 may evaluate a combination of the captured images and acceleration data to determine whether the vehicle has encountered a pothole. For example, the certainty of the captured images is above the determined threshold as described above and the acceleration data of the signal is above a respective threshold are both in agreement that there is a threshold, the processor(s) 204 may determine the certainty of the environmental condition is above the threshold and cause the computing device 202 to notify another computing device or computing system. If neither the captured images nor the acceleration data reaches their respective thresholds, the processor(s) 204 may determine it is not necessary to notify another computing device or computing system. In some examples, if only one of the captured images and the acceleration data indicates a pothole, the processor(s) 204 may hold notifying another computing device or computing system until both sensed data are above their respective thresholds. In other examples, the processor(s) 204 may compute the certainty based on an average of the sensed data in case that only one of the sensed data is above the threshold. If the average of the sensed data is above the threshold, the processor(s) 204 may determine the certainty is above the threshold and notify another computing device or computing system about the pothole. In some examples, the computing device 202 may receive weather alerts from weather alert services. The processor(s) 204 may lower the threshold if there is an existing weather alert related to environmental condition.

While it is shown that the processor(s) 204 is housed in the computing device 202 in FIG. 2, it is possible that an external processor coupled to the processor(s) 204 may analyze the sensor data and determine the certainty of the detected environmental condition. For example, the computing device 202 (e.g., the first vehicle 106 of FIG. 1) may transmit a report to a computing system (e.g., the computing system 110 of FIG. 1), the computing system 110 may notify another computing device of the environmental condition if the number of reports exceeds a predetermined threshold using the executable instructions for notifying another computing device 216 as shown in FIG. 2. The threshold may be based on quantity of reports, frequency of received reports, or combinations thereof. Accordingly, when the environmental condition is no longer present, the quantity of reports and frequency of received reports by the computing system 110 decline and may be below the threshold. The computing system 110 may determine the environmental condition is no longer present and not notify another computing device of an environmental condition that was previously present. In some examples, if the other computing device has already received notifications about the environmental condition, the executable instructions for notifying another computing device 216 may cause the computing system 110 to notify the other computing device 202 (e.g., the second vehicle 108 of FIG. 1) that the environmental condition is no longer present.

According to the second embodiment, during operation, the sensor(s) 206 may detect a dynamic road condition (e.g., the dynamic road condition of FIG. 1). The dynamic road condition may be a traffic light, a stop sign, a speed limit change sign, construction activity, road closure, detour route, a school zone indicator, a warning sign, a road sign, or combinations thereof. The sensor(s) 206 may send the sensor data to the processor(s) 204. The processor(s) 204 may compare the sensor data received from sensor(s) 206 with stored data relating to various states of the dynamic road conditions. After identifying the state of the dynamic road condition (e.g., color of traffic light), the processor(s) 204 may load the executable instructions for notifying another computing device 216 to inform another computing device in proximity of the states of the dynamic road condition via a transceiver (e.g., the transceiver 114 and/or transceiver 130 of FIG. 1). In other examples, the transceiver may notify a computing system (e.g., the computing system 110 of FIG. 1) about the state of the dynamic road condition. The other computing device or computing system may receive the state of the dynamic road condition and integrate the state of the dynamic road condition on a display map.

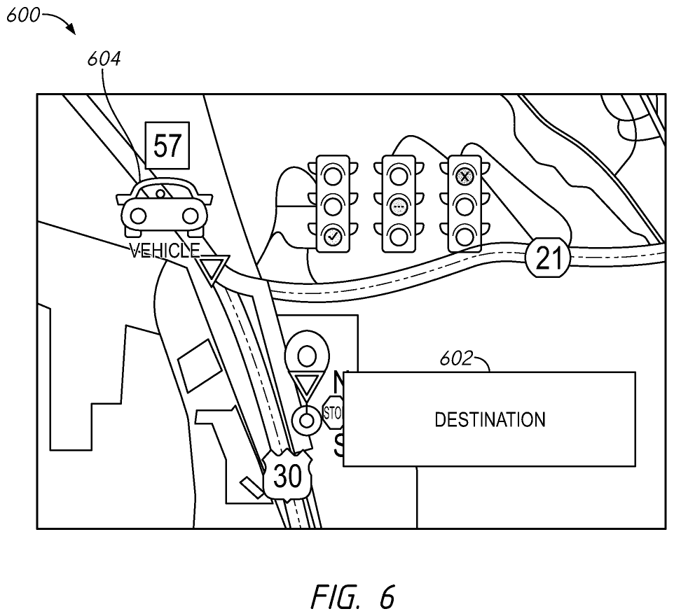

In some examples, the processor(s) 204 may execute the executable instructions for integrating environmental condition or dynamic road condition with map 218. During operation, a navigation map is generated for a user from a start point to a destination or an end point. The display 208 may display an updated navigation map showing the environmental condition or the dynamic road condition based on the user's preferences stored in the memory 212. An example updated navigation map may be seen in FIG. 6 where the color of the traffic light is shown on the navigation map. Optionally, an associated reminder of action may be displayed and/or verbally communicated to the user. For example, if the traffic light is red, the computing device 202 that displays the state of the traffic light may show a red traffic light on the map with a cross indicating “STOP.” Additionally or alternatively, the computing device 202 may generate a verbal alert with a speaker that the user should stop.

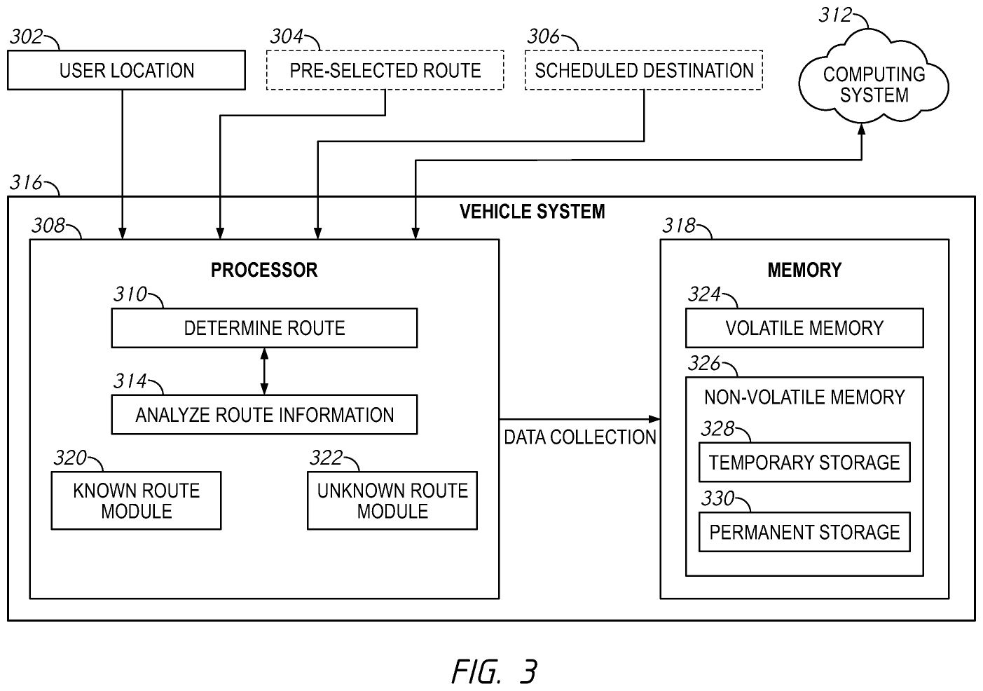

FIG. 3 illustrates an example system according to embodiments described herein to determine whether an identified route is known or new. The computing system 312 may be used to implement or implemented by, for example, the computing system 110 of FIG. 1 and/or the processor(s) 204 of FIG. 2. The vehicle system 316 may be used to implement or implemented by, for example, the vehicle computing system 116 of FIG. 1, the vehicle computing system 132 of FIG. 1, and/or the computing device 202 of FIG. 2. The computing system 312 may be coupled (via wired or wireless coupling) to the vehicle system 316. The vehicle system 316 may include a processor 308 coupled to a memory 318 in a data collection storage process.

The processor 308 may be implemented by or used to implement, for example, the processor(s) 126, processor(s) 142 of FIG. 1, and/or processor(s) 204 of FIG. 2. For example, the executable instructions for processor(s) 204 may include instructions for generating a navigation map of FIG. 3. Prior to departure, the processor 308 of FIG. 3 may collect input, from the user, such as user location 302 (e.g., GPS location), optionally pre-selected route 304, and optionally scheduled destination 306 based on a calendar event, a reservation, and/or time of day. The processor 308 may determine a recommended route based on the input (e.g. determine route 310). In some examples, the route may be updated during the drive (e.g., for any detours). The processor 308 may analyze route information (e.g., analyze route information 314) by comparing route information with prior route GPS logs. In some examples, the route GPS logs are provided in map data previously downloaded and saved in memory 318 for offline use or current local map data available online. The current local map data may be used to update existing map data in local storage (e.g., memory 318). The processor 308 may be coupled to a computing system 312. The computing system 312 may implement the computing system 110 of FIG. 1 or computing device 202 of FIG. 2. In some examples, the computing system 312 may be a cloud.

The processor 308 includes a known route module 320 and an unknown route module 322 If the determined route matches a route stored in the memory 318, the processor 308 may utilize the known route module 320. If the determined route does not match a route stored in the memory 318, the processor 308 may utilize the unknown route module 322. Both modules 320 and 322 may integrate the environmental condition and/or dynamic road condition as described above with respect to FIG. 1 and FIG. 2.

The memory 318 may be used to implement the memory 124, memory 140 of FIG. 1 and/or memory 212 of FIG. 2. The memory 318 includes volatile memory 324 and non-volatile memory 326. The non-volatile memory 326 includes temporary storage 328 and permanent storage 330. The volatile memory 324 may include current route data loaded from non-volatile memory 326 and/or cloud storage. For example, the current route data may include existing map, exit information, traffic signals locations, and/or road sign signals. The volatile memory 324 may be for short term storage and data may be discarded, or used to update the non-volatile memory 326. The non-volatile memory 326 includes temporary storage 328 and permanent storage 330. The temporary storage 328 stores current route data of a new route, including existing map, traffic signals locations, and/or road signs locations. Stored route data may be discarded if the route data is not accessed at a predetermined frequency to ensure available storage space for other new routes. In some examples, frequently accessed route data stored in the temporary storage 328 may be moved to permanent storage 330. The permanent storage 330 include current route data of a local or known route. The route data includes existing map, traffic signals locations, and/or road sign locations.

The known route module 320 may load local route information from the permanent storage 330 to the volatile memory 324. Any new route information determined by the processor 308 may be added to the volatile memory 324, where the new route information is used to update the permanent storage 330 before being discarded. New route data may additionally or alternatively provided from cloud or computing system 312. For example, the processor 308 may collect new images of the known route and road sign data during route and compare the images and road sign data to prior local route data stored in the permanent storage 330. During data collection, any new data may be saved to the volatile memory 324 before the permanent storage 330 is updated with new images and road sign data.

The unknown route module 322 may load unknown route information from the temporary storage 328 to the volatile memory 324. Any new route information determined by the processor 308 maybe added to the volatile memory 324 where the new route information is used to update the temporary storage 328 before being discarded. The processor 308 may access the computing system 312 to load any route data available. The sensors may collect additional new images and road sign data of the unknown route. New route data including data downloaded from the computing system 312 and/or collected data may be stored into the temporary storage 328. During data collection, any new data may be saved to the volatile memory 324 before the temporary storage 328 is updated with new images and road sign data.

Computing system 312 may receive updates of the route from the vehicle system 316 implemented by vehicle (e.g., first vehicle 106 and/or second vehicle 108 of FIG. 1) and/or computing device 202 when there is connection. The computing system 312 may compare received data from the vehicle system 316 with stored data in computing system 312 and flag any differences between the data. The updated data may include static data, such as locations of traffic signs. The updated data may include dynamic data, such as an indication that a pothole is filled or a road construction is complete. In some examples, the collected data may be compared with thresholds to determine a certainty of the state of the static or dynamic data, similarly to the detection of environmental condition 102 and/or dynamic road condition 104 as described with respect to FIGS. 1 and 2.

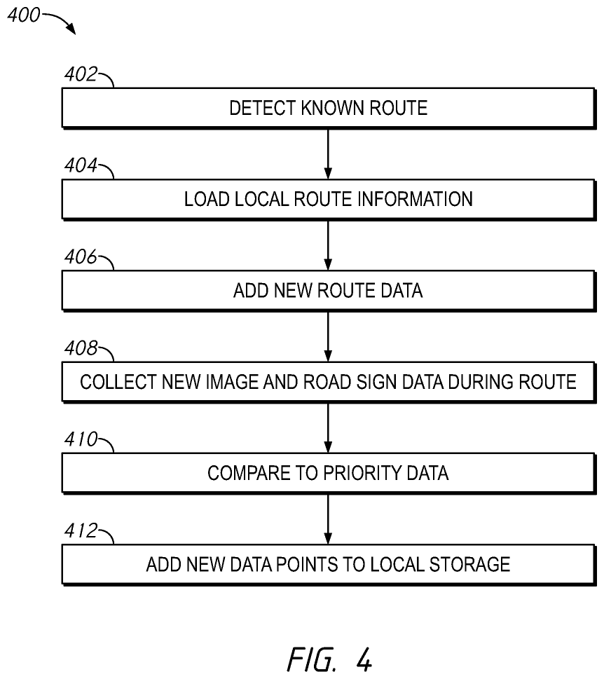

FIG. 4 is a flowchart illustrating a method arranged in accordance with examples described herein. Method 400 includes block 402, block 404, block 406, block 408, block 410, and block 412. In block 402, the processor 308 may analyze a recommended route between a start point and end point of navigation and determine the route is a known local route. In block 404, which may follow block 402, local route information may be loaded from permanent storage 330 of FIG. 3. The block 406 may follow block 404. In block 406, the processor 308 of FIG. 3 may receive new route data from a vehicle or computing device such as first vehicle 106 and/or second vehicle 108 of FIG. 1. Block 408 may follow block 406. In block 408, the processor 308 may collect new images and road sign data from the sensor(s) 112 of the first vehicle 106 and/or the sensor(s) 128 of the second vehicle 108 during the vehicle is en route. Block 410 may follow block 408. In block 410, the processor 308 may compare the stored route information with route data collected from the vehicle. Block 412 may follow block 410. In block 412, the processor 308 may determine there exists new route data relative to the stored data and add new data points to permanent storage 330. Additional, fewer, and/or otherwise ordered blocks may be used in other examples. The method 400 may be performed, for example, by vehicles described herein, such as by first vehicle 106 and/or second vehicle 108 of FIG. 1. The method may be performed, as another example, by computing devices and systems described herein, such as by computing system 110 of FIG. 1, computing device 202 of FIG. 2, and/or vehicle system 316 of FIG. 3.

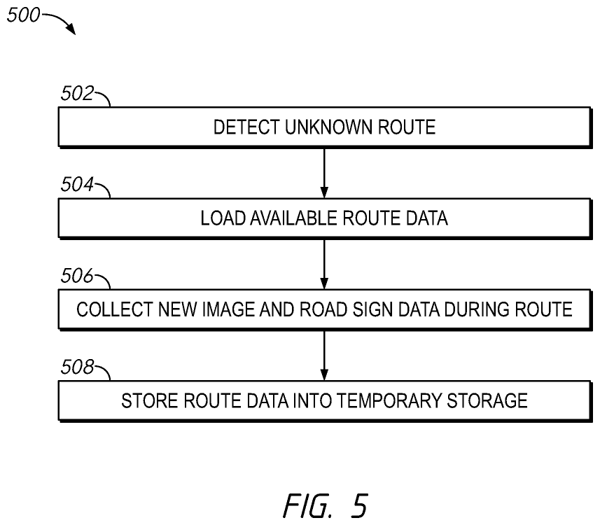

FIG. 5 is a flowchart illustrating a method arranged in accordance with examples described herein. FIG. 5 is a flowchart illustrating a method arranged in accordance with examples described herein. Method 500 includes block 502, block 504, block 506, and block 508. In block 402, the processor 308 may analyze a recommended route between a start point and end point of navigation and determine the route is an unknown route. In block 504, which may follow block 502, available route information may be loaded from computing system 312 of FIG. 3 via 3G/4G/5G cellular network. The block 506 may follow block 504. In block 506, the processor 308 of FIG. 3 may collect new images and road sign data from the sensor(s) 112 of the first vehicle 106 and/or the sensor(s) 128 of the second vehicle 108 during the vehicle is en route. Block 508 may follow block 506. In block 508, the processor 308 may store the route data into temporary storage 328 of FIG. 3 Additional, fewer, and/or otherwise ordered blocks may be used in other examples. The method 500 may be performed, for example, by vehicles described herein, such as by first vehicle 106 and/or second vehicle 108 of FIG. 1. The method may be performed, as another example, by computing devices and systems described herein, such as by computing system 110 of FIG. 1, computing device 202 of FIG. 2, and/or vehicle system 316 of FIG. 3.

FIG. 6 is a schematic illustration of an example navigation map integrating a state of a dynamic road condition in accordance with examples described herein. The navigation map 600 shows a commute for vehicle 604 with a destination 602. The vehicle 604 may be implemented by the first vehicle 106, second vehicle 108 of FIG. 1 computing device 202 of FIG. 2, and/or vehicle system 316 of FIG. 3. For example, navigation map 600 may be provided on display 118 and/or display 134. As shown in FIG. 6, a traffic light is incorporated on a route between vehicle 604 and the destination 602. The state of the traffic light may be provided by another vehicle (e.g., first vehicle 106 of FIG. 1) in proximity of the traffic light. The navigation system of vehicle 604 may incorporate the state of the traffic light next to the traffic light. The display of vehicle 604 may display an updated navigation map including the state of the traffic light. In some examples, the display may include an indication that red light is associated with “stop,” yellow light is associated with “slow down,” and green light is associated with “go.”

Prior to driving, map data for an entire local region may be downloaded for offline use. In some examples, the navigation map 600 may generate and provide a plurality of routes for vehicle 604 to arrive at the destination 602. For the plurality of routes, the offline map may include traffic infrastructure information, such as static data as described with respect FIG. 3. Nearby and possible detour routes may also be included in the static data. Traffic signs, road construction signs may be downloaded with the offline map as dynamic data. For example, a road construction may include an expected end date of road construction that may be processed by any processor shown in FIGS. 1 to 3. In another example, the vehicle 604 may have downloaded data indicating the presence of a pothole. The sensor(s) of vehicle 604 generates sensor data and the processor(s) of the vehicle 604 determines the pothole is no longer present on the route. The vehicle 604 may notify other vehicles or computing systems in proximity that the pothole is not on the route. In other examples, real-time data detected by the sensors of the vehicle (e.g., sensor(s) 112, sensor(s) 128 of FIG. 1, and/or sensor(s) 206 of FIG. 2) may be reported to the driver as dynamic real-time data. Dynamic real-time data may include traffic light color and the association with stop, slow down, or go. Dynamic real-time data may be reported to other vehicles or computing systems as a state of dynamic road condition may be notified to other vehicles in proximity.

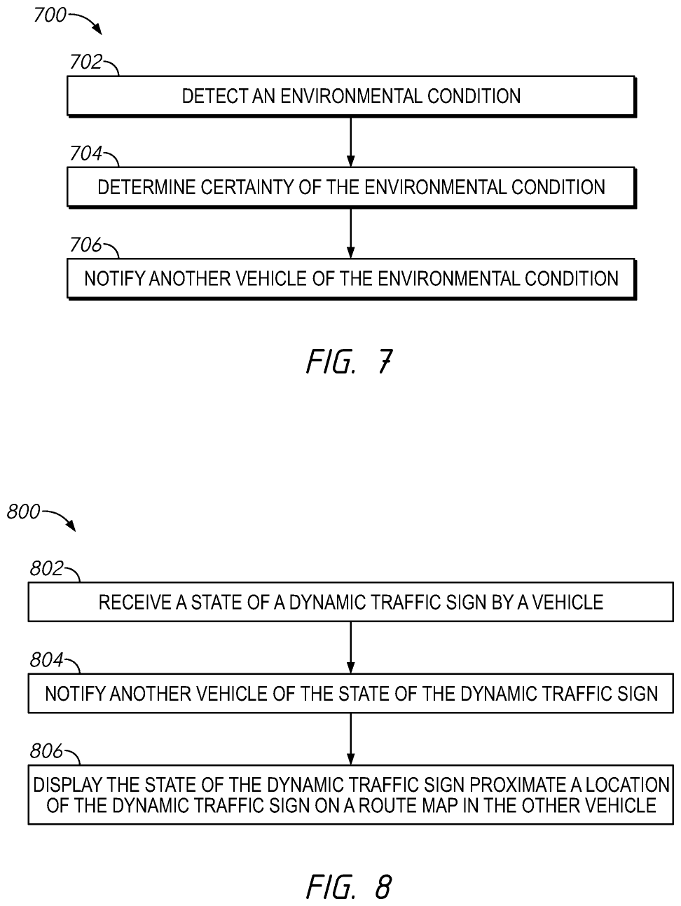

FIG. 7 is a flowchart illustrating a method arranged in accordance with examples described herein. Method 700 includes block 702, block 704, and block 706. In block 702, an environmental condition may be received or detected by a vehicle, such as the first vehicle 106 or the second vehicle 108. In block 704, which may follow block 702, a processor may determine certainty of the environmental condition. In block 706, which may follow block 704, a transceiver may notify another vehicle of the environmental condition if, for example, the certainty is equal to or above a threshold. Additional, fewer, and/or otherwise ordered blocks may be used in other examples. The method 700 may be performed by the first vehicle 106 or the second vehicle 108 of FIG. 1. In other embodiments, the method 700 may be performed by the computing system 110 and the first vehicle 106 or the second vehicle 108 of FIG. 1. The method 700 may additionally or alternatively be performed by the computing device 202 of FIG. 2.

An example that the method 700 implemented by the first vehicle 106 of FIG. 1 is discussed, that is, the first vehicle 106 detects an environmental condition. However, the corresponding parts of the second vehicle 108 may be used to implement method 700 should the second vehicle 108 be the vehicle that detects the environmental condition.

In block 702, the sensor(s) 112 of the first vehicle 106 may detect an environmental condition. The environmental condition (e.g. environmental condition 102) may be a pothole, rockslide, rising water level, snow, road closure, fallen tree, fallen objects (e.g. ladder, log), wildfires, strong winds, or combinations thereof. The sensor(s) 112 of the first vehicle 106 may generate sensor data corresponding to the environmental condition to be analyzed in block 704 by the processor(s) 126 of FIG. 1.

In block 704, the processor(s) 126 of the vehicle computing system 116 of the first vehicle 106 may use one or more criteria to identify the environmental condition and determine a certainty of the environmental condition following the detection of the environmental condition in block 702. The processor(s) 126 of the first vehicle 106 may analyze the sensor data and identify the type of the environmental condition. For example, the processor(s) 126 may compare the sensor data with a threshold stored in the memory 124. The threshold may be a minimum certainty (e.g., confidence value) that the environmental condition exists. The threshold may be a similarity between the sensor data and the stored data associated with the types of stored environmental conditions stored in memory 124. The threshold may be based on a frequency of the detection of the environmental condition or dynamic road condition. In the event that the certainty meets the threshold, the processor(s) 126 may cause the transceiver 114 to transmit a report of the environmental condition to the computing system 110 and/or the second vehicle 108 of FIG. 1.

In block 706, the transceiver 114 of the first vehicle 106 may transmit a report pertaining to the environmental condition to another vehicle (e.g., the second vehicle 108 of FIG. 1) based on the other vehicle having a route that is proximate the environmental condition and the other vehicle's notification preferences. In some examples, the transceiver 114 may directly communicate with the transceiver 130 of the second vehicle 108. In other examples, the transceiver 114 may transmit the report to the computing system 110 of FIG. 1, which may forward the transceiver 130 of the second vehicle 108.

In another example, in block 702, the sensor(s) 112 of the first vehicle 106 may detect an environmental condition and generate the sensor data. The processor(s) 126 may cause the transceiver 114 of the first vehicle 106 to transmit the sensor data to the computing system 110 of FIG. 1. In block 704, the computing system 110 may process the sensor data and determine the certainty of the environmental condition. The computing system 110 may analyze the sensor data and identify the type of the environmental condition. For example, the computing system 110 may compare the sensor data with a threshold stored in the memory in the computing system 110 (not shown in FIG. 1). The threshold may be a minimum certainty (e.g., confidence value) that the environmental condition exists. The threshold may be a similarity between the sensor data and the stored data associated with the types of stored environmental conditions stored in the memory. In the event that the certainty meets the threshold, the computing system 110 may transmit a report of the environmental condition to the second vehicle 108 of FIG. 1 as shown in block 706.

In other examples, the method 700 may be implemented by the computing device 202 of FIG. 2. As previously discussed, the computing device 202 may be used to implement the first vehicle 106, the second vehicle 108, and/or the computing system 110 of FIG. 1.

In block 702, the sensor(s) 206 of the computing device 202 of FIG. 2 may detect an environmental condition. The sensor(s) 206 of the computing device 202 may generate sensor data corresponding to the environmental condition to be analyzed in block 704 by the processor(s) 204 of FIG. 2. In some examples, the detection of the environmental condition and the analysis of the sensor data may be performed based on the executable instructions for detection of environmental condition or dynamic road condition 214 stored in the memory 212.

In block 704, the processor(s) 204 of the computing device 202 may use one or more criteria to identify the environmental condition and determine a certainty of the environmental condition following the detection of the environmental condition in block 702 according to the executable instructions for detection of environmental condition or dynamic road condition 214. The processor(s) 204 of the computing device 202 may analyze the sensor data and identify the type of the environmental condition. For example, the processor(s) 204 may compare the sensor data with a threshold stored in the memory 212. The threshold may be a minimum certainty (e.g., confidence value) that the environmental condition exists. The threshold may be a similarity between the sensor data and the stored data associated with the types of stored environmental conditions stored in memory 212. The threshold may be a frequency of the detection of the environmental condition or dynamic road condition. In the event that the certainty meets the threshold, the processor(s) 204 may transmit a report of the environmental condition to the other computing device (e.g., another computing device 202) of FIG. 2 according to the executable instructions for notifying another computing device 216.

In block 706, the processor(s) 204 of the computing device 202 may execute the executable instructions for notifying another computing device 216 stored in the memory 212 if the certainty of the environmental condition reaches a predetermined threshold in block 704. The other computing device may have a route proximate the environmental condition and the other vehicle's notification preferences. The computing device 202 may directly communicate with another vehicle or a remote network implementing the computing device 202. In some examples, the computing device 202 may determine the environmental condition is no longer present and not notify another computing device accordingly. In some examples, if the other computing device has already received notifications about the environmental condition, the executable instructions for notifying another computing device 216 may cause the computing device 202 to notify another computing device 202 that the environmental condition is no longer present.

FIG. 8 is a flowchart illustrating a method arranged in accordance with examples described herein. Method 800 includes block 802, block 804, and block 806. In block 802, a vehicle, such as the first vehicle 106 or second vehicle 108 of FIG. 1 and/or the computing device 202 of FIG. 2, may receive a state of a dynamic traffic sign (or a dynamic road condition such as dynamic road condition 104). In block 804, which may follow block 802, the vehicle may notify another vehicle (e.g., the other one of the first vehicle 106 and the second vehicle 108 of FIG. 1 or another computing device 202 of FIG. 2) having a route proximate the dynamic traffic of the state of the dynamic traffic sign. In block 806, which may follow block 804, the other vehicle that receives the state of the dynamic traffic sign may integrate the state of the dynamic traffic sign proximate a location of the dynamic traffic sign in a route map. Additional, fewer, and/or otherwise ordered blocks may be sued in other examples.

An example that the method 800 implemented by the first vehicle 106 and the second vehicle 108 of FIG. 1 is discussed. For example, the first vehicle 106 may detect a state of a dynamic road condition and the second vehicle 108 may receive a state of the dynamic road condition from the first vehicle 106. In another example, the second vehicle 108 may detect a state of a dynamic road condition and the first vehicle 106 may receive a state of the dynamic road condition. For brevity, the following discussion illustrates the example that the first vehicle 106 receives a state of the dynamic road condition and the second vehicle 108 receives the state of the dynamic road condition from the first vehicle 106. However, the example should not be interpreted as limiting to the implementation of method 800. In some examples, the computing device 202 of FIG. 2 may be implemented by the first vehicle 106 and/or the second vehicle 108.

In block 802, the sensor(s) 112 of the first vehicle 106 of FIG. 1 may receive a state of the dynamic road condition (e.g. dynamic road condition 104). Examples of dynamic traffic signs include constructions, fallen trees, car accidents, speed trap, color of the traffic light etc. The sensor(s) 112 of the first vehicle 106 may generate sensor data corresponding to the dynamic road condition to be analyzed and send the sensor data to the processor(s) 126. The processor(s) 126 may compare the sensor data received from sensor(s) 112 with stored data relating to various states of the dynamic road conditions to identify the state of the dynamic road condition according to executable instructions for detection of environmental condition or dynamic road condition 214 in the memory 212 of FIG. 2.

In block 804, following block 802, after identifying the state of the dynamic road condition (e.g., color of traffic light), the processor(s) 126 of the first vehicle 106, which may implement the computing device 202 of FIG. 2, may load the executable instructions for notifying another computing device 216 to inform another computing device in proximity (e.g. second vehicle 108 of FIG. 1) of the state of the dynamic road condition via a transceiver (e.g., the transceiver 114 of FIG. 1). In other examples, the transceiver may notify a computing system (e.g., the computing system 110 of FIG. 1) about the state of the dynamic road condition. The computing system 110 may be a remote computing system. In some examples, the data related to the dynamic road condition is sent to another computing device or another computing system responsive to the certainty of the detected dynamic road condition being higher than a threshold. In other examples, the data related to the dynamic road condition is transmitted to another computing device or another computing system regardless of the certainty. For example, the data may be transmitted to the computing system 110 of FIG. 1 and the computing system 110 determines a certainty of the dynamic road condition based on a frequency or number of reports before notifying other vehicles of the dynamic road condition. The other computing device or computing system may receive the state of the dynamic road condition and integrate the state of the dynamic road condition on a display map as shown in block 806.

In block 806, the transceiver 130 of the second vehicle 108 may receive the state of the dynamic traffic sign from the first vehicle 106 and display the state of the dynamic traffic sign on a route map displayed on display 134 of the second vehicle 108 of FIG. 1. When the transceiver 130 of the second vehicle 108 receives data pertaining to the dynamic road condition 104 from the first vehicle 106 that is proximate the dynamic road condition, the processor(s) 142 of the second vehicle 108 may cause the display 134 to display the dynamic road condition based on the executable instructions for integrating environmental condition or dynamic road condition with map 218. The second vehicle 108 may include a communication interface (not shown in FIG. 1), allowing a user of the second vehicle 108 to provide their preferences for the display, frequency of receiving a status of the dynamic road condition 104, notification means, types of dynamic road condition 104 that trigger a notification, feedback about the notifications, or combinations thereof. The user's preferences may be stored in the memory 140. The communication interface of the second vehicle 108 may be implemented by the communication interface 210 of the computing device 202 of FIG. 2. The memory 140 may also store the map data and a library of dynamic road conditions as described above. The processor(s) 142 of the second vehicle 108 may integrate the state of the dynamic traffic sign with the map data and generate a new navigation map based on the integration. The processor(s) 142 may use the controller 138 to cause the display 134 to display the new navigation map. The processor(s) 142 may use the controller 138 to cause the speaker 136 to audibly describe the state of the dynamic road condition 104.

Navigation systems described herein may detect and communicate environmental conditions and/or dynamic road conditions with other vehicles, and allow updates to existing road conditions to be shared among vehicles in more efficiently. A driver may also appreciate examples according to various aspects of the present disclosure for the detailed information associated with the road conditions and/or environmental conditions. The navigation system described herein may integrate the environmental condition and/or dynamic road condition in the navigation map and re-route as needed. Thus, an efficient route taking into account details of road conditions and dynamic road conditions that may be updated in real-time may be provided to the user. These improvements also help the driver be aware of the surroundings and overall ensure safety to the road users.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A method comprising:
detecting an environmental condition using a sensor on a first vehicle;
determining certainty of the environmental condition above a first threshold; and
notifying another vehicle of the environmental condition based on the other vehicle having a route that is proximate the environmental condition and the other vehicle's notification preferences.

2. The method of claim 1, wherein determining the certainty of the environmental condition above the first threshold comprises:
receiving multiple reports of the environmental condition from vehicles;
predicting an anticipated traffic along the route; and
establishing the first threshold as a threshold number of reports based at least on the anticipated traffic;
determining the certainty of the environmental condition is above the first threshold when a number of the multiple reports is greater than the threshold number.

3. The method of claim 2, further comprising:
calculating a percentage of vehicles reporting the environmental condition along the route over a predetermined time period and adjusting the first threshold based on the number of reports; and
adjusting the first threshold based at least on the percentage of vehicles.

4. The method of claim 1, further comprising:
determining the certainty is below a second threshold lower than the first threshold; and
notifying the other vehicle that the environmental condition has been resolved.

5. The method of claim 1, further comprising:
calculating the certainty of the environmental condition based on a time lapse since the environmental condition is detected or traffic usage.

6. The method of claim 1, further comprising:
generating a plurality of alternative routes for the other vehicle responsive to the certainty of the environmental condition above the first threshold.

7. The method of claim 6, further comprising:
selecting an alternative route of the plurality of alternative routes based on traffic conditions, additional environmental conditions, and vehicle preferences.

8. The method of claim 1, further comprising:
displaying the environmental condition on a route map in the other vehicle.

9. The method of claim 1, wherein the environmental condition comprises a pothole, rockslide, rising water level, snow, road closure, fallen tree, ladder, log, wildfires, strong winds, or combinations thereof.

10. A method comprising:
receiving a state of a dynamic traffic sign by a vehicle;
notifying another vehicle of the state of the dynamic traffic sign based on the other vehicle having a route that is proximate the dynamic traffic sign; and
displaying the state of the dynamic traffic sign proximate a location of the dynamic traffic sign on a route map in the other vehicle.

11. The method of claim 10, wherein the dynamic traffic sign comprises: a traffic light, a stop sign, a speed limit change sign, construction activity, road closure, detour route, a school zone indicator, a warning sign, a road sign, or combinations thereof.

12. The method of claim 10, further comprising:
identifying the vehicle is located in a region where an alert is issued;
notifying the vehicle of the alert; and
displaying an option to view the alert.

13. The method of claim 10, further comprising:
receiving feedback from a user for selective display of the state of the dynamic traffic sign.

14. The method of claim 10, further comprising:
integrating the dynamic traffic sign with map data stored on a local storage of the vehicle; and
predicting an updated travel time based on the integration of the dynamic traffic sign and the map data.

15. The method of claim 14, wherein the map data comprises roads, intersections, user preferences, existing map information, road signs, exit information, and locations of traffic lights.

16. An apparatus comprising:
a processor configured to search for a route between a start point and an end point;
a transceiver configured to receive a state of a dynamic traffic sign on the route from a vehicle proximate the dynamic traffic sign;
a storage configured to store map data and user's preference comprising preference for display of the state of the dynamic traffic sign;
the processor further configured to:
integrate the state of the dynamic traffic sign with the map data;
generate a navigation map based on the integration; and
identify a second route between the start point and the end point, wherein the second route does not include the dynamic traffic sign; and
a display configured to display the navigation map including the integration of the dynamic traffic sign.

17. The apparatus of claim 16, wherein the processor is further configured to:
predict a travel time associated with the route and a second travel time associated with the second route;
determine the second travel time is less than the travel time; and
generate the navigation map using the second route.

18. The apparatus of claim 16, further comprising:
a speaker configured to audibly describe the state of the dynamic traffic sign based on the user's preference, wherein the user's preference further comprises preference for audio notification.

19. The apparatus of claim 16, wherein the user's preference further comprises preference for types of alerts to be displayed, wherein the transceiver is further configured to receive an alert issued for a region the vehicle is in, and wherein the display is configured to show the alert.

20. The apparatus of claim 16, wherein the dynamic traffic sign comprises: a traffic light, stop sign, speed limit change indicator, construction activity, road closure, detour route, school zone indicator, a warning sign, a road sign, or combinations thereof.
